(19) United States
(12) Patent Application Publication
(10) Pub. No.: US 2016/0328760 A1
(43) Pub. Date: Nov. 10, 2016

(54) FEEDBACK SYSTEM AND METHOD

(71) Applicant: RatingBox Pty Ltd, Melbourne (AU)

(72) Inventor: Guy Phillip William King, Toorak (AU)

(21) Appl. No.: 15/145,569

(22) Filed: May 3, 2016

(30) Foreign Application Priority Data
May 7, 2015 (AU) 2015901656
Sep. 30, 2015 (AU) 2015234323

(51) Int. Cl. G06Q 30/02; G06F 3/0484; H04L 29/06

(52) U.S. Cl. CPC G06Q 30/0282; H04L 67/42; G06F 3/04842

(57) ABSTRACT

A feedback system, comprising a console comprising a feedback interface and a console body, the console body housing a processor and a wireless communications module, wherein the console body supports the feedback interface; wherein the feedback interface comprises a plurality of feedback buttons, each feedback button comprising an image indicative of a different type of feedback, wherein pressing of one of the feedback buttons is recorded by the processor and communicated by the wireless communications module to a server; wherein the console further comprises a motion detector positioned to detect motion occurring in a region towards which the feedback interface is facing, the motion detector being in communication with the processor to provide a detector output to the processor; and wherein the processor is configured to communicate motion data based on the detector output to the server via the wireless communication module.

### TECHNICAL FIELD

Described embodiments generally relate to feedback systems and methods. In particular, embodiments involve the use of a feedback console.

### BACKGROUND

Customer feedback is important in allowing a business or other service provider to determine the satisfaction level of its customer base. However, obtaining customer feedback is not always easy and customers sometimes do not wish to spend time to provide feedback to the establishment seeking it. For example, online surveys or telephone surveys often take ten to twenty minutes or sometimes more for the customer to complete and this represents a time burden on the customer so the proportion of customers who actually complete such surveys is low. Customer feedback systems and methods that represent a minimal time burden on the customer are therefore desirable.

It is desired to address or ameliorate one or more shortcomings or disadvantages of prior customer feedback systems and methods, or to at least provide a useful alternative thereto.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

### SUMMARY

Some embodiments relate to a feedback system, comprising:

a console comprising a feedback interface and a console body, the console body housing a processor and a wireless communications module, wherein the console body supports the feedback interface;

wherein the feedback interface comprises a plurality of feedback buttons, each feedback button comprising an image indicative of a different type of feedback, wherein pressing of one of the feedback buttons is recorded by the processor and communicated by the wireless communications module to a server;

wherein the console further comprises a motion detector positioned to detect motion occurring in a region towards which the feedback interface is facing, the motion detector being in communication with the processor to provide a detector output to the processor; and

wherein the processor is configured to communicate motion data based on the detector output to the server via the wireless communication module.

The pressing of one of the buttons may be communicated to the server within a short period of the pressing. The pressing may be communicated to the server substantially immediately.

The processor may determine the motion data based on the detector outputs received over a first period of time. The first period of time may be between about 1 minute and about 2 hours. The processor may determine the motion data based on a sum of the detector outputs received over the first period of time.

The motion detector may comprise a passive infra-red sensor.

The system may further comprise a temperature sensor arranged to sense a temperature in the vicinity of the console. The temperature sensor may be coupled to the processor to provide a temperature output to the processor, wherein the processor is configured to communicate temperature data based on the temperature output to the server.

The system may further comprise a noise sensor arranged to sense an environmental noise level in the vicinity of the console, the noise sensor coupled to the processor to provide a noise level output to the processor, wherein the processor is configured to communicate noise level data based on the noise level output to the server.

The system may further comprise at least one environmental sensor to sense environmental conditions in a vicinity of the console, the at least one environmental sensor coupled to the processor to provide environmental condition output to the processor, wherein the processor is configured to communicate environmental condition data based on the environmental condition output to the server.

The console may have associated therewith a private unique identifier, wherein communications to the server from the console comprise the private unique identifier.

The console may have associated therewith a public unique identifier, wherein communications to the server from the console comprise the public unique identifier and the private unique identifier.

The processor may be configured to cause one or more of the buttons to illuminate in response to an event, wherein the event is one of: one of the buttons being pressed; or motion being detected in front of the console by the motion detector. The console body may comprise mounting structure on an opposite side from the feedback interface to mount the console to a mounting bracket.

The system may further comprise the server. The server may host an application programming interface (API) to allow remote device access to the motion data and to feedback data based on the pressing of the feedback buttons. The API may further allow remote device access to other stored sensor data associated with one or more of the consoles. The API may further allow remote device access to aggregated data and/or computed metrics associated with one or more of the consoles. The API may be configured to require identification of an account identifier and an API key in a data request received by the API from a remote device in order to provide data in response to the request. The server may be configured to cooperate with one or more client devices to provide a graphical user interface (GUI) on the one or more client devices, the GUI allowing display of information based on the motion data and based on the pressing of the feedback buttons.

For each communication received from the console, the server may be configured to determine whether the private unique identifier is valid, wherein if the private unique identifier is determined to be valid, a data payload of the communication is stored in a data store accessible to the remote server, and wherein if the private unique identifier is determined not to be valid, the communication is discarded.

The system may comprise multiple ones of the console each in communication with the server, wherein the server is configured to selectively allow a client device to access stored data received from one or more of the consoles.

Some embodiments relate to a method for recording feedback, comprising:

receiving a feedback input at a feedback console comprising a feedback interface and a console body, the feedback input being received via one of a plurality of feedback buttons on the feedback interface;

receiving motion signals from a motion detector coupled to the console, the motion detector being arranged to detect motion occurring in a region towards which the feedback interface is facing; and communicating feedback data based on the feedback input to a server remote from the console and communicating motion data based on the motion signals to the server.

The communicating feedback data and the communicating motion data may occur under different conditions. The motion data may be based on aggregated motion information over a time interval. The feedback data is communicated to the server substantially immediately in response to receiving the feedback input.

### BRIEF DESCRIPTION OF DRAWINGS

Embodiments are described in further detail below, by way of example, and with reference to the accompanying drawings, in which:

FIG. 1 is a block diagram of a feedback system according to some embodiments;

FIG. 2 is a schematic illustration of a feedback console according to some embodiments;

FIG. 3 is a block diagram of the feedback console of FIG. 2;

FIG. 4 is a block diagram of part of the system of FIG. 1, showing components of a server and client device in further detail;

FIG. 5 is an illustration of an example display on the feedback console;

FIG. 6 is an example client device display including graphics to illustrate summary information based on data received from the console;

FIG. 7 is a further example client device display including graphics to illustrate aggregated feedback information based on data received from the console or more than one such console;

FIG. 8 is a flowchart of a method of providing feedback messages from a feedback console to a remote server;

FIG. 9 is a flowchart of a method of processing feedback messages received at the server from one or more feedback consoles;

FIG. 10 is a flowchart of a method of providing motion data from a feedback console to the remote server;

FIG. 11 is a flowchart of a method of providing environmental data from a feedback console to the remote server;

FIG. 12 is a flowchart of a method of automatically generating client notifications based on aggregated feedback data and other data;

FIG. 13 is a perspective view of an example feedback console according to some embodiments;

FIGS. 14A and 14B are perspective views illustrating wall-mounting of the console of FIG. 13;

FIG. 15 is a perspective view of another example feedback console according to some embodiments;

FIG. 16 is a perspective view of feedback console of FIG. 15, seen from a different perspective;

FIG. 17 is an example screenshot of a client device display of a user account dashboard showing multiple feedback consoles registered for the same user account;

FIG. 18 is an example screenshot of a client device display of a settings page for a user account;

FIG. 19 is an example screenshot of summary analytics information for feedback received via one or more feedback consoles;

FIG. 20 is an example screenshot of summary analytics information for activity (motion data) received via one or more feedback consoles; and

FIG. 21 is an example screenshot of summary insight information for feedback and activity received via one or more feedback consoles.

### DESCRIPTION OF EMBODIMENTS

Described embodiments generally relate to feedback systems and methods. In particular, embodiments involve the use of a feedback console. The console may comprise a motion detector and/or environmental sensors.

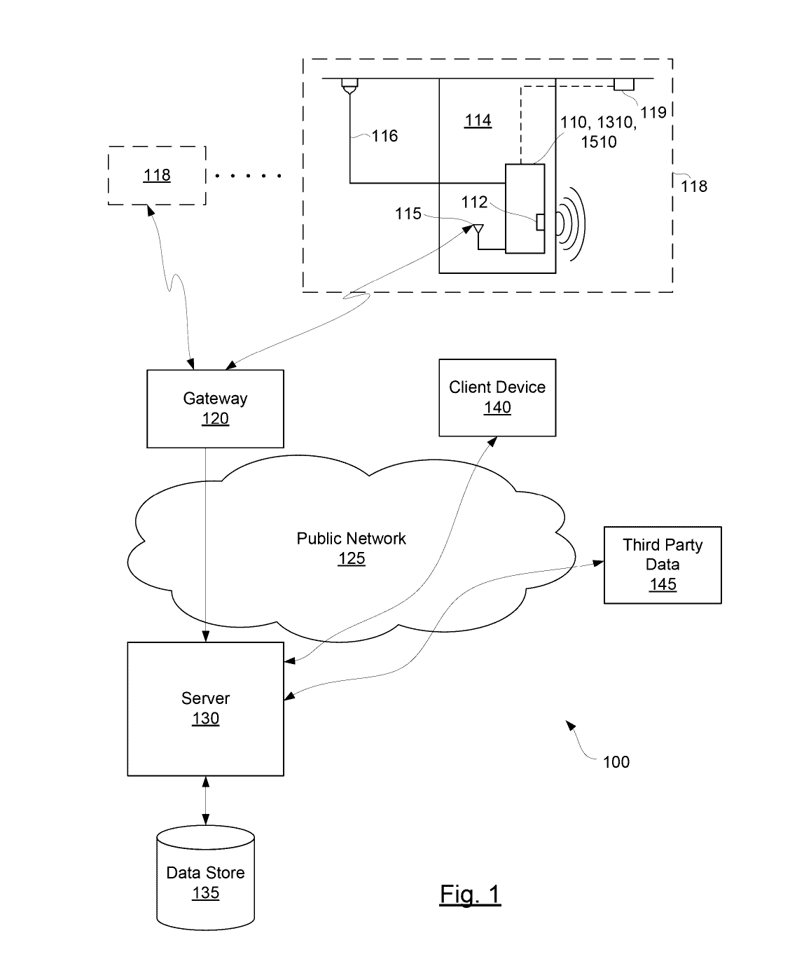

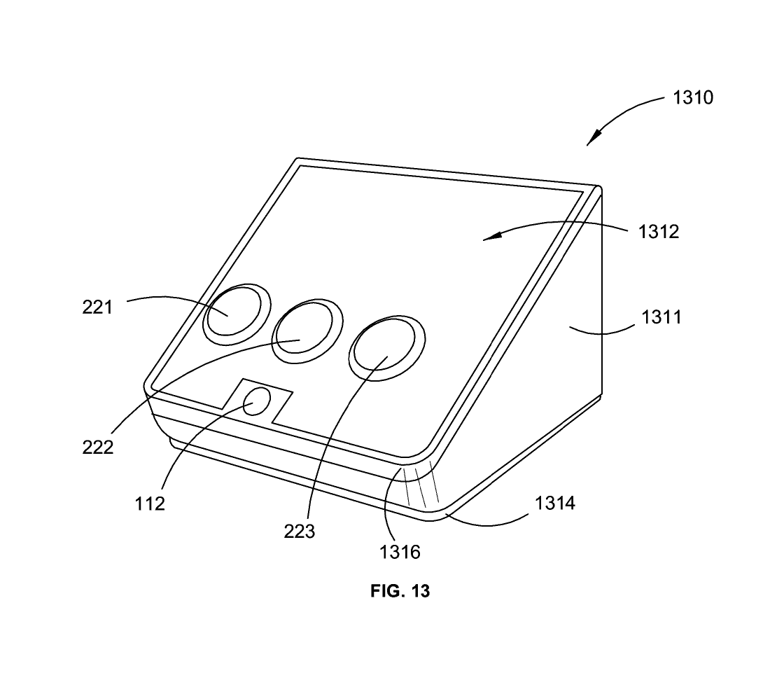

Referring firstly to FIG. 1, a feedback system 100 is illustrated. The feedback system 100 comprises at least one, and possibly multiple or many, feedback consoles 110 in communication with a server 130 that may be located remotely from the feedback console 110. Feedback consoles 1310 and 1510 according to alternative embodiments are described below with reference to FIGS. 13 to 16. Because the differences among the embodiments are primarily physical configuration features (e.g. related to the device housing) and not electrical/computational functions or operation, for ease of description, a reference hereinto feedback console 110 should be taken to include a reference to feedback consoles 1310 and 1510, except in relation to the description of FIGS. 13 to 16 below.

The feedback console 110 may communicate with the server 130 via a gateway 120, such as a cellular data gateway or another kind of network node through which wired or wireless messaging can be transmitted. Gateway 120 is in communication with the server 130 over a public network 125, such as the Internet. System 100 further comprises a data store 135 accessible to the server 130 to store pertinent data arising from or associated with use of each at least feedback console 110. The data store 135 may be or comprise a dedicated data store for server 130 or it may be or comprise a virtualised data store accessible over the public network 135, for example.

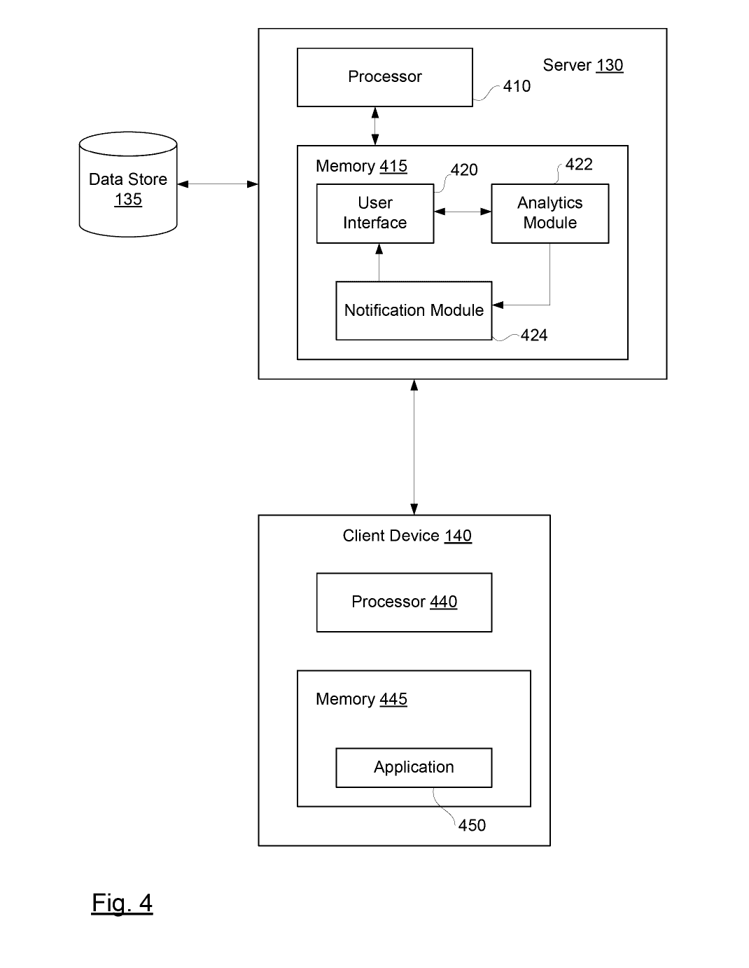

The system 100 further comprises at least one client device 160, and may comprise many client devices 140, in communication with the server 130 over the public network 125. Interaction of the one or more client devices 140 with the server 130 is described in further detail in relation to FIG. 4. Server 130 may also be in communication with a third party data 145 source, such as a web service or another server, to obtain information, such as weather data, from a source other than local sensors.

Each feedback console 110 is positioned in an establishment, building or other localised environment 118 that is frequented by customers or guests from which it is desired to receive feedback relating to such customers' or guests' experiences in the establishment, building or other localised environment 118. For example, the establishment, building or localised environment 118 may include, but not be limited to, a retail shop, a restaurant or café, a salon, a service kiosk, a transport hub (e.g. an airport, train station or bus terminal), a park, museum or other public amenity, an amusement establishment (e.g. a cinema, gaming venue or theme park) or other analogous locations. For convenience, embodiments are described further herein in relation to an establishment 118 that provides direct customer service experiences, such as a restaurant, café, retail shop or salon, by way of non-limiting examples. The establishment 118 may commonly have a desk, pedestal or counter 114 at which a customer may be served and at which the customer may provide payment for goods or services received. The feedback console 110 may be mounted or positioned on the desk, pedestal or counter 114 or possibly near an exit point of the establishment. The feedback console 110 may receive mains power via a suitable cable 116 coupled to the feedback console 110 and connected to a local mains power supply.

The feedback console 110 has at least one antenna 115 for wireless communication with server 130, either via a local wireless hub or via a cellular base station. The feedback console 110 comprises a motion detector 112 positioned to detect motion in the immediate vicinity in a front direction of the feedback console 110. Thus, for example, where the feedback console 110 is positioned on a counter at which customers receive service or pay for goods or services, the motion detector 112 and feedback console 110 are positioned to face the immediate vicinity in which such customers are likely to walk. Thus the motion of customers in front of the feedback console 110 can be detected by the motion detector 112.

In addition to the motion detector 112, the feedback console 110 may have one or more other environmental sensors 119 communicatively coupled or connected (wired or wirelessly) to the feedback console 110. Such environmental sensors 119 may include one or more of noise, temperature, light, humidity, air quality sensors or other local environment sensors. The environmental sensors 119 may be substantially co-located with the feedback console 110 and/or located within a few metres or tens of metres of the feedback console, for example within 2-50 metres.

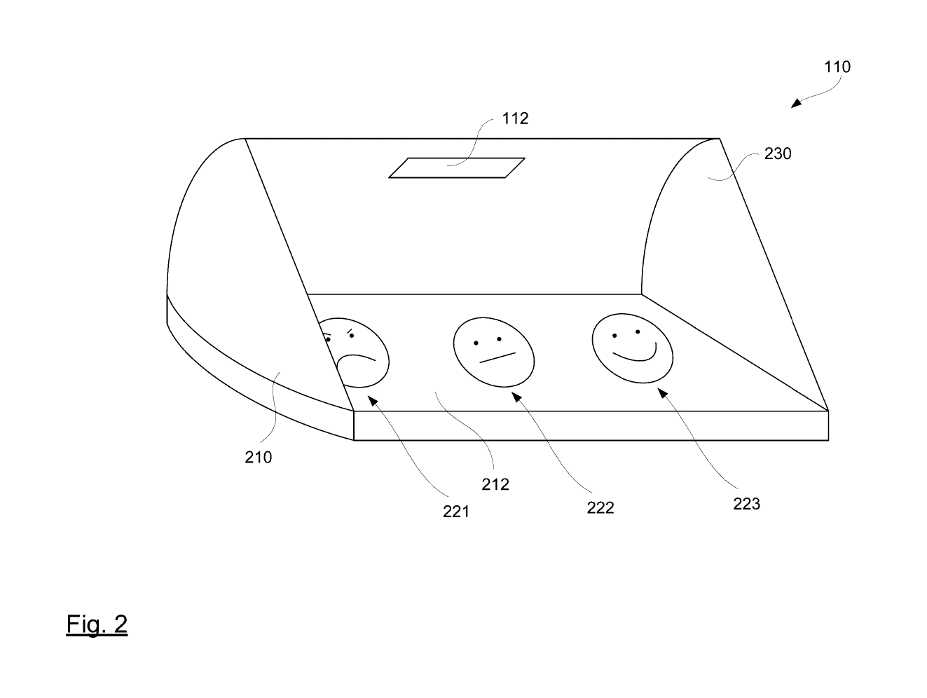

Referring now to FIG. 2, a physical arrangement of the feedback console 110 is illustrated and described in further detail. The console 110 comprises a housing 210 with a console interface area 212 that comprises a presentation display and a series of input components, optionally in the form of buttons 221, 222 and 223. The buttons 221, 222 and 223 may be physically depressible buttons. Alternatively, the interface area 212 may be provided as a touch-screen interface, in which case the buttons 221, 222 and 223 may be selectable screen objects. The buttons 221, 222 and 223 may be illuminated (e.g. back-lit) by respective light sources, either constantly or selectively. For example, a button may be illuminated in response to being pressed or if all of the buttons are already illuminated when one of the buttons is pressed, the one pressed button may remain illuminated while the other buttons cease to be illuminated.

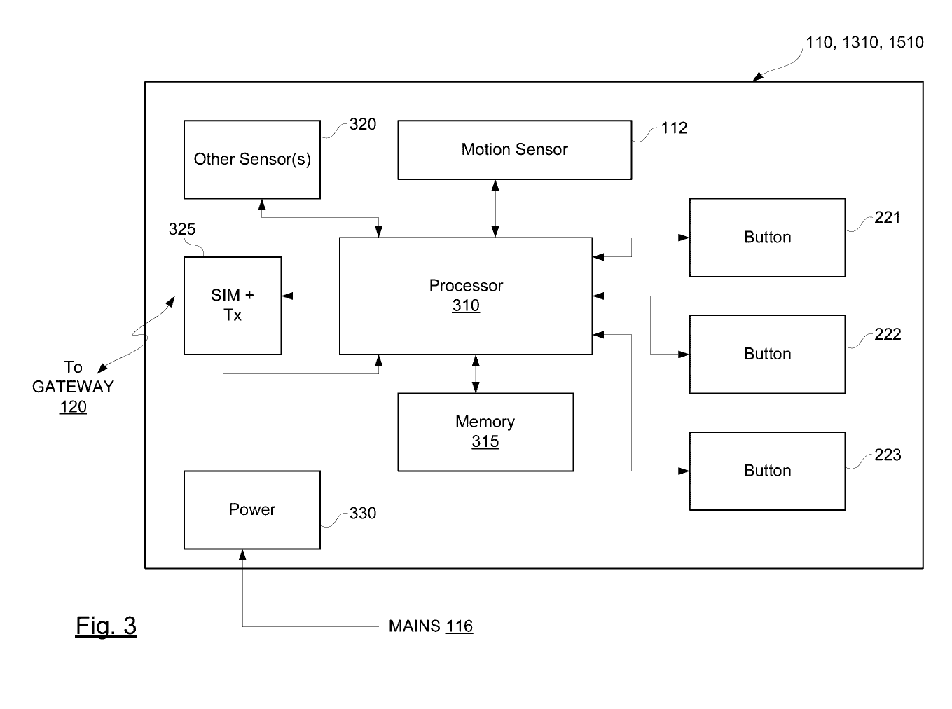

The buttons 221, 222 and 223 are spaced across a surface of the interface area 212 and each such button has a different image associated therewith (i.e. displayed thereon) and indicating a notional level of satisfaction. For example, a first button 221 may have a sad face depicted on it, so that if the button 221 is pressed, an indication of negative feedback is recorded. As another example, a second button 222 may have a neutral face displayed on it, so that if a person presses the second button 222, a neutral feedback indication is recorded. In a further example, a third button 223 may have a happy face displayed on it, so that if the third button 223 is pressed, a positive feedback indication is recorded. Such feedback indications are recorded in a memory 315 (FIG. 3) of the console 110.

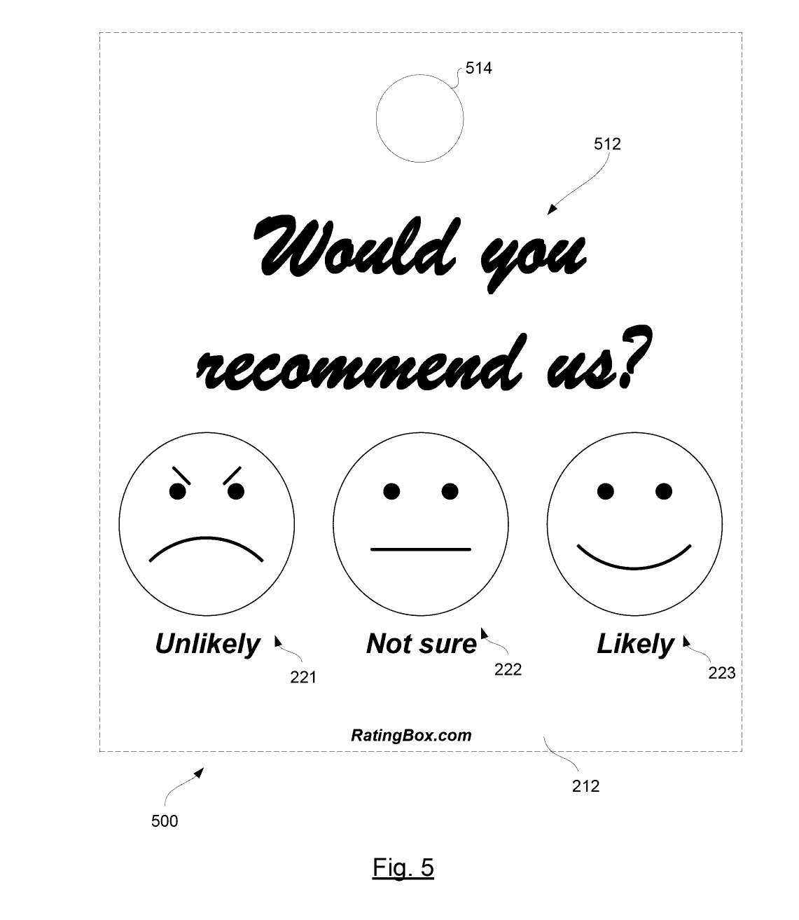

FIG. 5 illustrates an example display 500 of the console 110 and of the interface area 212 in particular. The display 500 may include the buttons, 221, 222 and 223, plus some text 512 to solicit feedback. Optionally, the text may be targeted to toward receiving feedback on a particular topic, for example by framing a question that can be answered by a person pressing one of the buttons. Optionally, each of the buttons 221, 222, 223 may have text positioned on the display 500 adjacent the respective button to indicate the nature of the response associated with pressing the respective button. For example, the negative feedback button 221 may have the word “no” or “unhappy” or “unlikely” next to it, while the positive feedback button 223 may have the word “yes” or “happy” or “likely” next to it.

The display 500 may comprise a fixed or semi-permanent physical display in some embodiments or in other embodiments, the display 500 may be provided on a touch-sensitive screen, with the buttons being screen objects on the touch-sensitive screen. For embodiments using a touch-sensitive screen, the console 110 may house a tablet computing device, for example and the interface area 212 may be provided by a purpose-built software application executing on the tablet computing device. The display may have a small window 514 towards a top of the display area to allow (non-visible) light to pass therethrough for the operation of the motion detector 112 or alternatively to provide an indication of the level of activity being detected by the motion detector 112.

Although three buttons are shown in FIGS. 2, 3 and 5, a greater number of buttons may be displayed in order to receive a greater variety of feedback indications. However, there can be some benefit in limiting the number of different types of feedback indications that a customer can give, in order to make it as simple as possible for the customer to provide feedback and not require the customer to engage in much consideration of the feedback options. The buttons 221, 222 and 223 may be different colours and may be illuminated by a background light source, such as one or more LEDs.

The housing 210 may have side shields 230 to shield others from seeing the customer's choice of feedback. The motion detector 112 may be positioned at a suitable location toward an upper part of a rear hood or shroud of the housing 210.

The housing 210 includes electronics that are hidden from view and described in further detail in relation to FIG. 3. The housing 210 is substantially closed on three sides but open in a front direction via which the customer can access the feedback interface 212. It is also this front direction that the motion sensor 112 is directed towards to detect motion. Thus, if a customer stops in front of the console 110 and reaches toward a button, this will be detected by a motion sensor 112. Similarly, if the customer passes in front of the console 110, this will also be detected by the motion sensor 112.

The motion sensor 112 may comprise a passive infra-red motion detector. The motion detector 112 may be covered by a cover that is substantially transmissive and transparent for infra-red light while being substantially opaque to human-visible light. The motion sensor 112 may comprise an analog device that provides an output with a value indicative of the level of motion detected. For example, a low value, such as zero may be output where no motion is detected and a high value, such as a thousand or five thousand may be output when a lot of motion is detected.

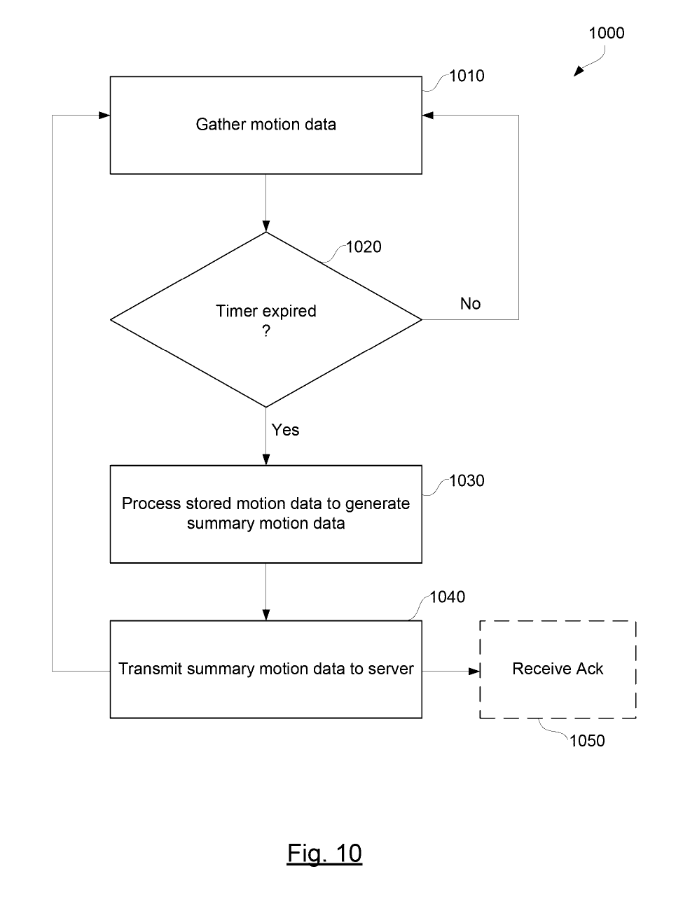

FIG. 10 illustrates a flowchart of a method 1000 of processing and transmitting motion data from the console 110 to the server 130. A motion detector output signal with a corresponding value indicative of the level of motion detected is generated by the motion sensor 112 and provided to a processor 310 (FIG. 3) within the housing 210 of the console 110, thereby gathering motion data (at 1010). This output signal from the motion sensor 112 may be provided periodically, such as every 100 milliseconds or at another short interval, for example (while the motion detector 112 receives power from the processor 310 or a power supply unit 330).

The processor 310 may store each output signal received from the motion sensor 112 for a period of time in the memory 315 or it may sum or otherwise aggregate and store the values provided in the output signals for a second period of time, such as one or several minutes up to an hour or two hours. After a preset interval of time has expired (at 1020), the processor 310 retrieves the itemised or aggregated motion data stored in the memory 315, generates a message (at 1030) to server 130 containing that motion data and sends the message (at 1040) to the server 130 via the gateway 120 using antenna 115. The server may send an acknowledgement of the message back to the console (at 1050). The preset interval between transmissions of the motion data to the server 130 may be an hour, for example, or alternatively 5, 10, 20 or 30 minutes or more than one hour. The processor 310 may cause motion sensor 112 to power down during certain hours in which the establishment 118 is not intended to be open, or alternatively the processor 310 may discard or ignore the signals received from the motion sensor 112 during such times.

Once the processor 310 transmits a message to the server 130 containing the motion sensor data, the motion sensor data stored for the previous interval may be deleted and new motion sensor data is recorded for the next interval.

As shown in FIG. 3, the feedback console 110 has a processor 310 (or more than one processor cooperating to perform data and signal processing functions) interfacing with a local memory 315, which stores firmware including programme code executable by the processor 310 to perform the data processing and communications functions described herein. The console 110 receives mains power 116 at a power supply unit 330, which provides appropriate power to processor 310 and other components of the feedback console 110, as necessary. For example, if buttons 221, 222 and 223 are lit by LEDs, then the power unit 330 may supply power to those LEDs.

The processor 310 may execute software code that causes the processor 310 to temporarily (e.g. for 1-5 seconds) light up (i.e. switch power to) light sources behind the buttons 221, 222 and 223 in response to an output signal received by the processor 310 from the motion detector 112 that indicates that motion was detected in front of, or otherwise near to, the feedback console 110. This may serve to attract the attention of a person as that person passes near the console and may result in increased feedback input.

Power to the antenna 115 may be supplied by power unit 330. All power to components of console 110 that require electrical energy in order to operate is provided directly from power unit 330 or via processor 310.

The console 110 has a communications unit 325, comprising a SIM card and a transceiver (including antenna 115) in order to communicate with the server 130.

In addition to motion sensor 112, feedback console 110 may comprise other sensors 320, such as sensors 119. The other sensors 320 may be housed in or incorporated in the console 110 or may be external to the console housing 210 and communicatively coupled therewith, either by a wire or wireless connection. Such other sensors 320 may include environmental sensors such as noise, humidity, temperature, precipitation or light sensors, for example.

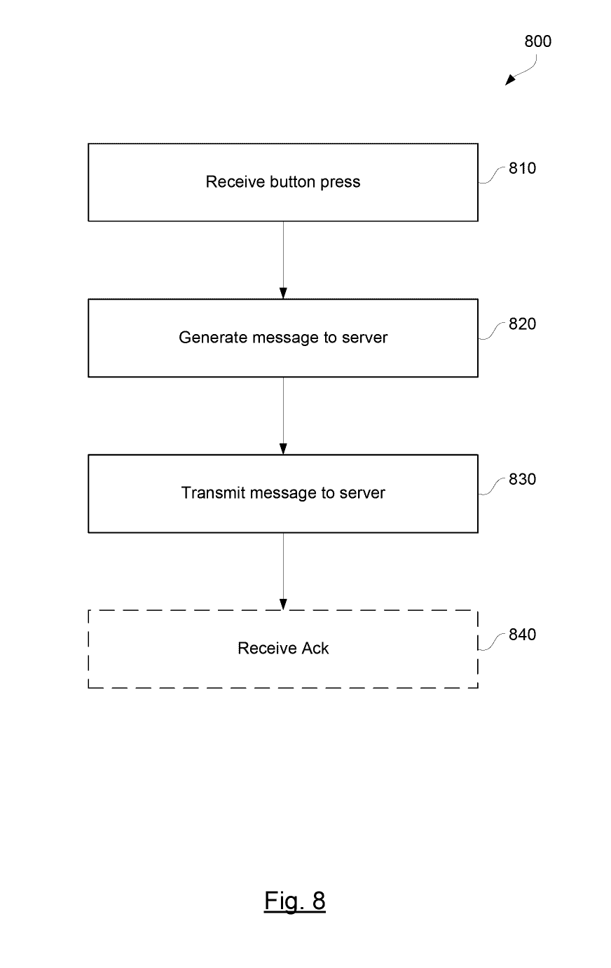

FIG. 8 illustrates a flowchart of a method 800 of providing feedback data from the console 110 to the server 130. When a button is pressed (at 810) on the interface area 212 of the console 110, the processor 310 receives an output signal from the respective button and immediately (i.e. within milliseconds or up to a few seconds) generates (at 820) and transmits (at 830) a message to server 130 to provide the customer feedback. This customer feedback message includes a date, time stamp and customer rating (e.g. sad/negative, neutral or happy/positive). The console 110 may receive an acknowledgement (at 840) message from the server 130 for each message successfully transmitted from the console 110.

Each message transmitted from the console 110 to the server 130 may include a public unique identifier for the console which may be printed on the back of the console housing 212, for example. Each message may also include a private unique identifier for the console 110, which is not ascertainable by visual inspection of the housing 210 but is embedded or stored in the firmware of the console 110. In some embodiments, only the private unique identifier may be used to identify the transmitting console to the server 130.

The public and private unique identifiers can be used by the server 130 to ensure that the message comes from a valid and authorised feedback console 110, for example by performing a database/table lookup to make sure that the public and private unique identifiers are a valid, matching pair. If the identifiers are not determined to be a valid matching pair, the message with the feedback information may be discarded. Otherwise, the customer feedback message is parsed to determine and store the feedback rating, time stamp and console identifier in the data store 135 for future reporting to a client device 140, as required. Optionally, the server 130 may transmit an acknowledgement message back to the console 110 if the public and private unique identifiers are determined to constitute a valid matching pair. In some embodiments, only the private unique identifier is sent in the messages to the server 130 from the feedback console 110.

As a failsafe against customer abuse of the feedback console 110, the processor 310 may be configured to ignore button presses that follow immediately within a few seconds of the initial button press. Alternatively, the console 110 may send feedback messages to the server 130 for each button press, but the server 130 may discard messages having a time stamp less than a certain number of seconds (e.g. 2, 3, 4, 5, 6, 7, 8, 9 or 10 seconds) from a previous feedback message. The latency period within which succeeding messages may be ignored may be specified in code stored in memory 315 and executed by processor 310 or may be configurable according to an end user preference entered via a client device 140 interfacing with the server 130, for example.

Referring also to FIG. 4, server 130 and client device 140 are shown in further detail. Server 130 comprises at least one processor 410 having access to a memory 415 of the server 130, as well as data store 135. The memory 415 stores executable programme code to implement software modules when executed by the processor 410. For example, the memory 415 stores code modules including a user interface module 420, an analytics module 422 and a notification module 424.

The user interface module 420 is responsible for receiving and processing messages from one or multiple feedback consoles 110 and for providing a user interface to client devices 140. The user interface module 420 thus also parses incoming requests from client devices 140 and serves code and data in response to such requests (including data accessed from data store 135). As described further below, the user interface module 420 may provide an application programming interface (API) to allow client devices with authorised client account credentials to automatically interface with the server 130 and data store 135 to extract stored data in relation to a particular client account. This can provide additional convenience by avoiding the need to have a user use a browser application 450 on a client device 140 to interface with the server 130 to request and view the same data.

The analytics module 422 periodically executes a series of rules, which may be stored in memory 415 or data store 135, configured by an administrative user to determine observations, events or information potentially of interest to the establishment 118.

The notification module 424 is configured to automatically notify one or more client devices 140 associated (in stored data records) with one or more consoles of information of interest arising from processing of the rules by the analytics module 422.

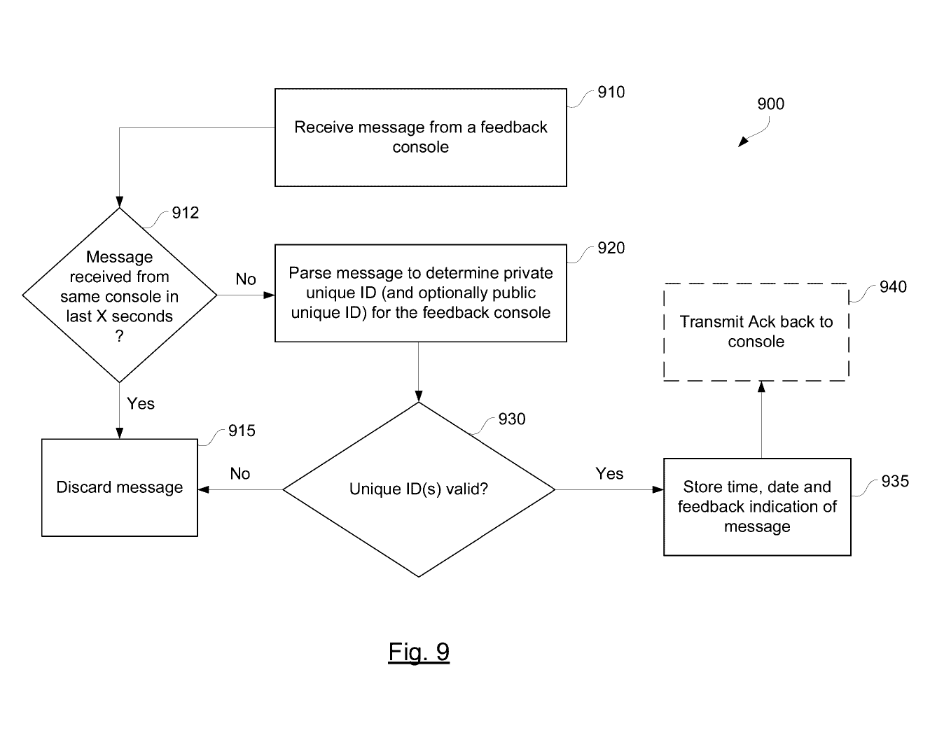

FIG. 9 illustrates a flowchart of a method 900 of processing feedback messages received from a feedback console at the remote server 130. At 910, the server receives a message from one of the consoles, for example via gateway 120. The processor 410 of the server 130 performs a check at 912 to determine whether a message was received from the same console with a time stamp that is within a configured number (X) of seconds of the message just received, and if so, the just-received message is discarded at 915. In this way, a subsequent button press within X seconds of the last button press is ignored, regardless of whether a button press message has been discarded or not. This provides a rolling timeout to block out excessively repetitious button-pressing. The configured number of seconds, X, may be 1, 2, 3, 4, 5, 6, 7, 8, 9 or 10 seconds, for example. This check is used to avoid recording a number of feedback inputs in quick succession, since this would tend to suggest that a single person may be improperly pressing a button multiple times, the result of which would be to make the overall feedback information received from that console inaccurate or distorted. As an alternative to discarding such spurious or excessive feedback inputs at the server 130, the processor 310 of the console 110 may be configured to not generate or transmit messages for feedback inputs that occur within X seconds from the first button-press. This X-second lockout period may be hard-coded into the console 110 or may be configured by server 130 (in response to authorised user input via a client device 140), for example.

In situations where multiple button presses occur in quick succession, the illumination of the buttons in response to being pressed may still occur as normal, in order to allow the person pressing the button excessively to think that their excessive feedback is being recorded (so that that person doesn't adopt more clever behaviour that might actually circumvent the X-second lockout). Alternatively, a button illuminated in response to a button press may stay illuminated for the X-second lockout period to indicate to the person that no further feedback input is permitted during that time.

If the message is determined at 912 not to have been received within X seconds from the previous message, then the message is parsed as normal at 920 to determine the private unique ID of the console 110 and optionally also the public unique ID of the console 110. If the server 410 determines that the private unique ID (or the public and private unique ID pair) is valid at 930, then the payload of the message is stored in the data store 135 at 935, including the timestamp (including exact time to the second and date) and feedback indication (e.g. happy/positive, neutral or unhappy/negative). If the private unique ID (or the public and private unique ID pair) is determined not to be valid at 930, then the message and its payload are discarded at 915 without being stored in data store 135.

As described above, the console 110 may comprise or have associated therewith and/or coupled thereto at least one environmental sensor 119 (as some or all of other sensors 320 shown in FIG. 3) to sense environmental conditions in a vicinity of the console 110. The at least one environmental sensor 119 is coupled to the processor 310 to provide environmental condition output to the processor 310, wherein the processor 310 is configured to communicate environmental condition data based on the environmental condition output to the server 130. The at least one environmental sensor 119 may comprise a noise sensor, a temperature sensor, a relative humidity sensor, an atmospheric pressure sensor, a rain sensor, a light level sensor, a wind sensor or other sensor to measure or detect one or more environmental conditions that might be of relevance to assessing conditions concerning human comfort. When coupled to the motion detector 112, which can act as a local activity indicator, the at least one environmental sensor 119 can be used to provide greater context to the received feedback information. For example, on days where a detected noise level is high, a larger proportion of negative feedback inputs may be correlated. The persons responsible for the establishment may infer a connection from this information and adapt their business practices to reduce ambient noise levels in an attempt receive less negative feedback.

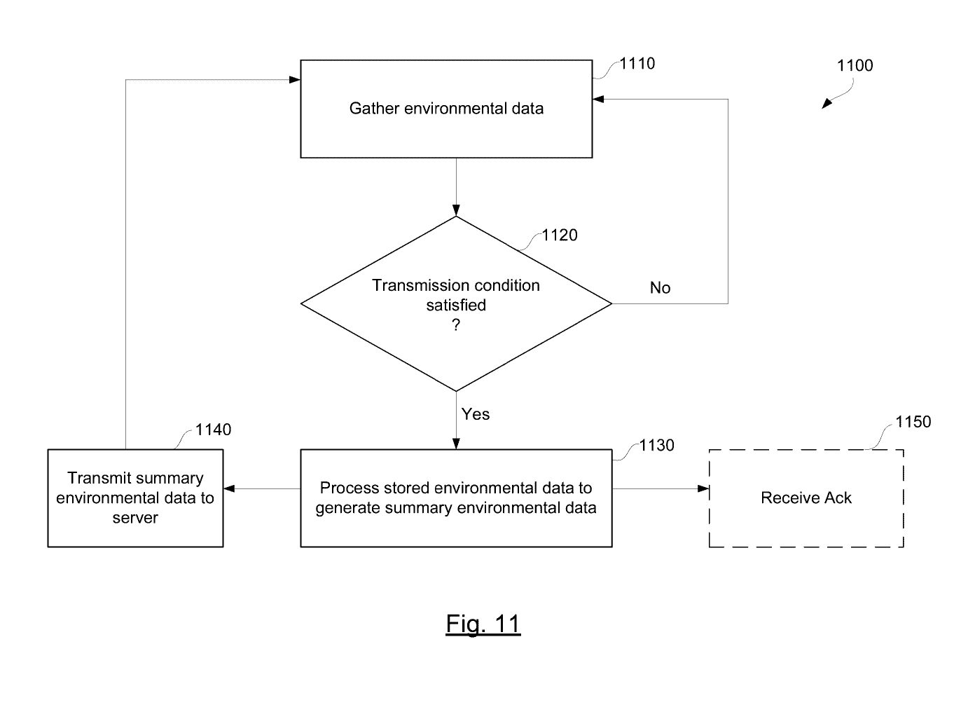

FIG. 11 illustrates a flowchart of a method 1100 similar to method 1000 but where the data being gathered is environmental sensor data, rather than motion data. The processor 310 may gather and store (at 1110) each output signal received from the at least one environmental sensor 119 for a period of time in the memory 315 or it may sum or otherwise aggregate and store the values provided in the output signals for a second period of time, such as one or several minutes up to an hour or two hours. After a preset interval of time has expired or another transmission condition is satisfied (at 1120), the processor 310 retrieves the itemised or aggregated environmental data stored in the memory 315, generates a message (at 1130) including a summary of the environmental data to server 130 containing that environmental data and sends the message (at 1140) to the server 130 via the gateway 120 using antenna 115. The server may send an acknowledgement of the message back to the console (at 1150). The preset interval between transmissions of the environmental data to the server 130 may be an hour, for example, or alternatively 5, 10, 20 or 30 minutes or more than one hour.

The processor 310 may cause the at least one environmental sensor 119 to power down during certain hours in which the establishment 118 is not intended to be open, or alternatively the processor 310 may discard or ignore the signals received from the at least one environmental sensor 119 during such times.

If multiple similar or different independent sensors are comprised in the at least one environmental sensor 119, then messages to the server 130 may be generated and sent by the console 110 for each such sensor or the data processed from the output signals of those sensors may be wrapped into the same message and sent from the console 110 to the server 130 at the same time.

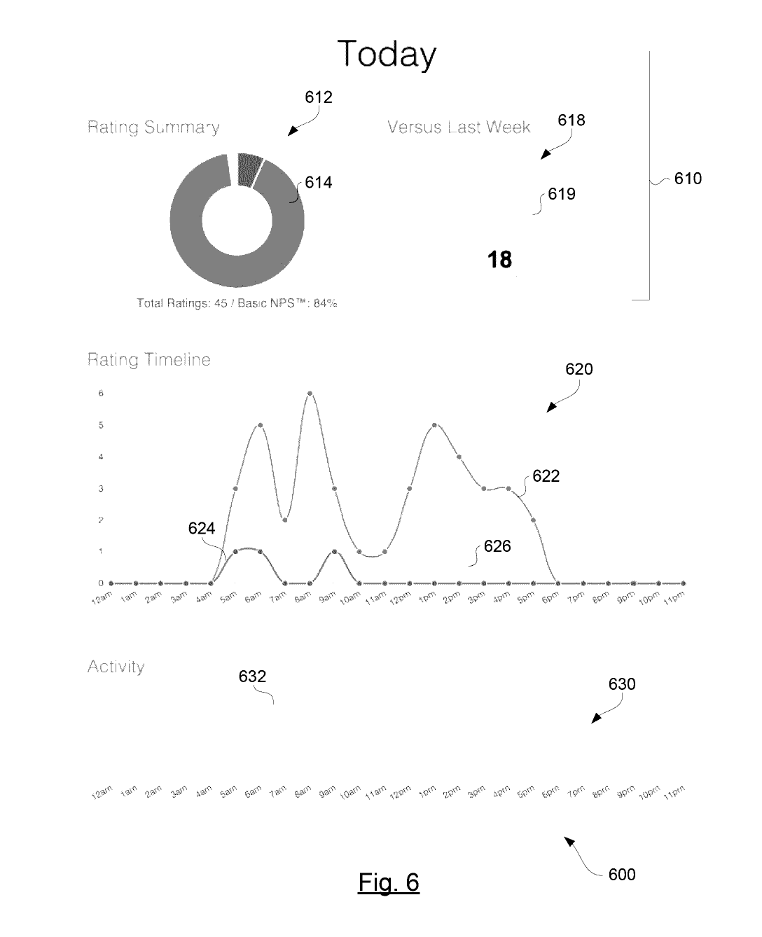

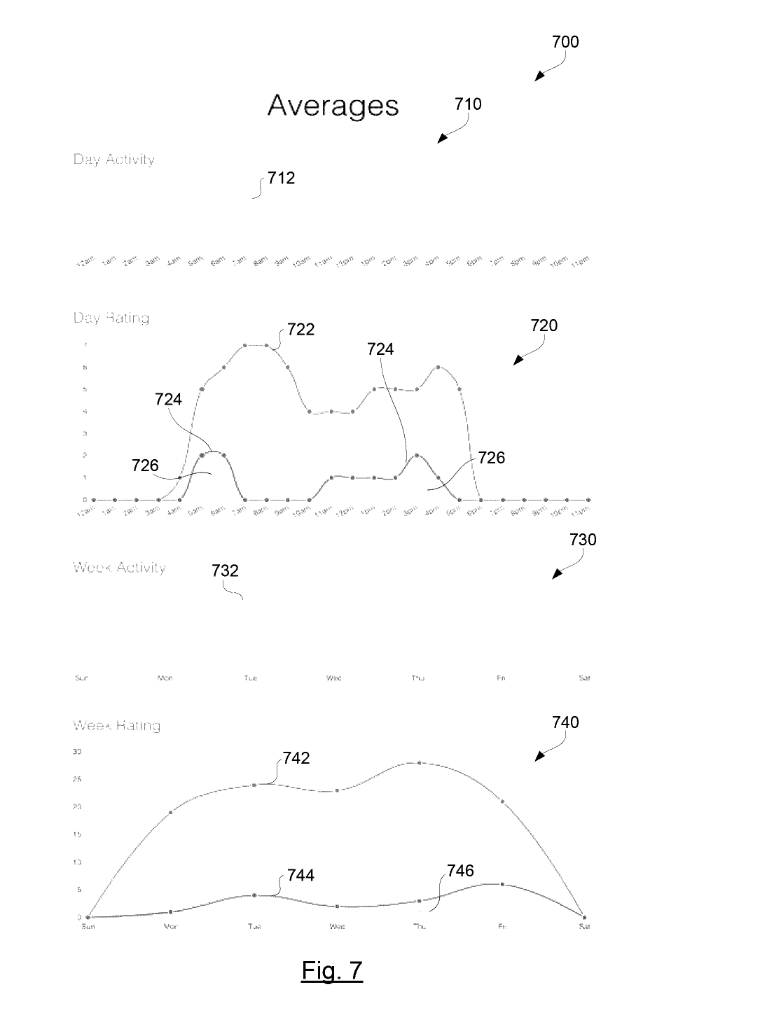

Referring to FIGS. 6 and 7, example user displays 600 and 700 are described. Such user displays 600 and 700 may be displayed to a user of a client device 140 via a browser application or a purpose-built application (“app”) 450, for example. Displays 600 and 700 effectively provide summary information of analytics of the feedback and motion data received at server 130 over time by one or more consoles 110. For example, an owner or manager of the establishment 118 within which the console 110 is located may wish to access the accumulated feedback and activity (motion) data for a day, a week, or other period of time via client device 140. The user interface 420 of server 130 may therefore generate and serve data and/or code to client device 140 (upon appropriate authentication and data requests received from client device 140) in relation to one or more feedback consoles 110 that are associated with a client account. For example, a café owner may wish to consider analytics displays, such as 600 and 700 for a single console 110 in a single establishment 118, while a franchisor may wish to consider analytics for multiple feedback consoles 110 positioned in multiple different franchise establishments 118.

The example display 600 shown in FIG. 6 may include various graphics, including charts, graphs, plots or other illustrative depictions of the data received via one or more consoles 110. The display 600 may be directed towards feedback and activity for a day and may comprise a summary section 610, with a rating summary 612 and a comparison section 618. The rating section 612 may show a pie chart or bar chart 614 to graphically illustrate the numbers of positive, neutral and negative feedback indications received for a particular period, such as a day. The comparative indication may provide a chart 619 to indicate how the current level of feedback compares to previous days or weeks or weekly averages, for example. The display 600 may further comprise a rating timelines chart 620, for example, including ratings for a certain time period of a positive nature 622, negative nature 624 or a neutral nature 626. The display 600 may further comprise an activity section 630, including a plot or graph 632 of activity level over a time period, such as a day. For example, the time scale for the rating timeline 620 and the activity section 630 may be a 24 hour time period, with the data points in the graph displayed at hourly intervals, with curves fitted across the data points.

The example display 700 may be directed to illustrating analytics for periods of more than the period displayed in display 600 (i.e. more than one day), for example showing weekly average activity, monthly average activity or average activities over other periods of time, and having these average activity levels displayed with respect to times of the day, for example including hours of normal business operation or hours in which it would be expected that customer feedback and activity might occur. In example display 700, a daily activity section 710 may be provided, including a graph 712 of the average daily activity (i.e. as sensed by the motion detector 112) over the course of 24 hours. Display 700 further includes a day rating section 720, that includes graphs indicating average feedback of a positive nature 722, neutral nature 724 and negative nature 726. Each of these graphs 722, 724 and 726 may be differently colour coded but superimposed on top of each other in order to be readily visually distinguishable and comparable, for example. The display 700 may further comprise a week activity section 730, including average activity levels for each day over a number of days, such as a week or a month, for example. Similarly, the display 700 may comprise a week rating section 740 that indicates the average feedback ratings received for each day across a number of days, such as a week or a month, for example. Week rating section 740 comprises a graph 742 indicating positive feedback averaged for each day, a neutral graph 744 indicating neutral feedback averaged for each day and a negative graph indicating negative feedback averaged for each day.

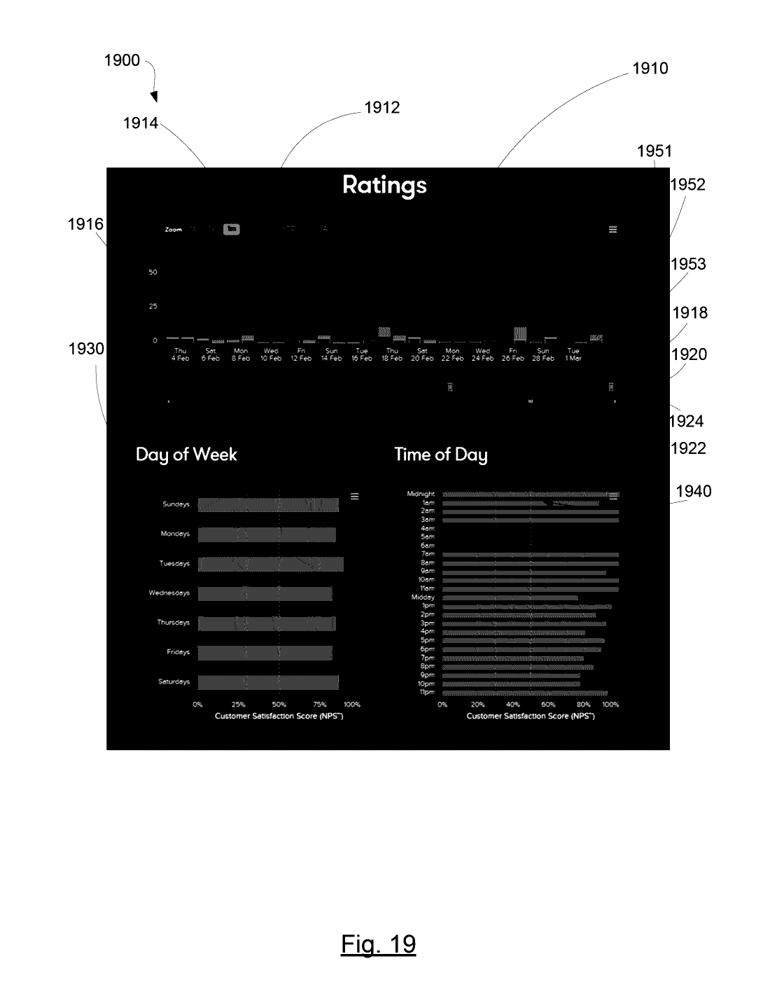

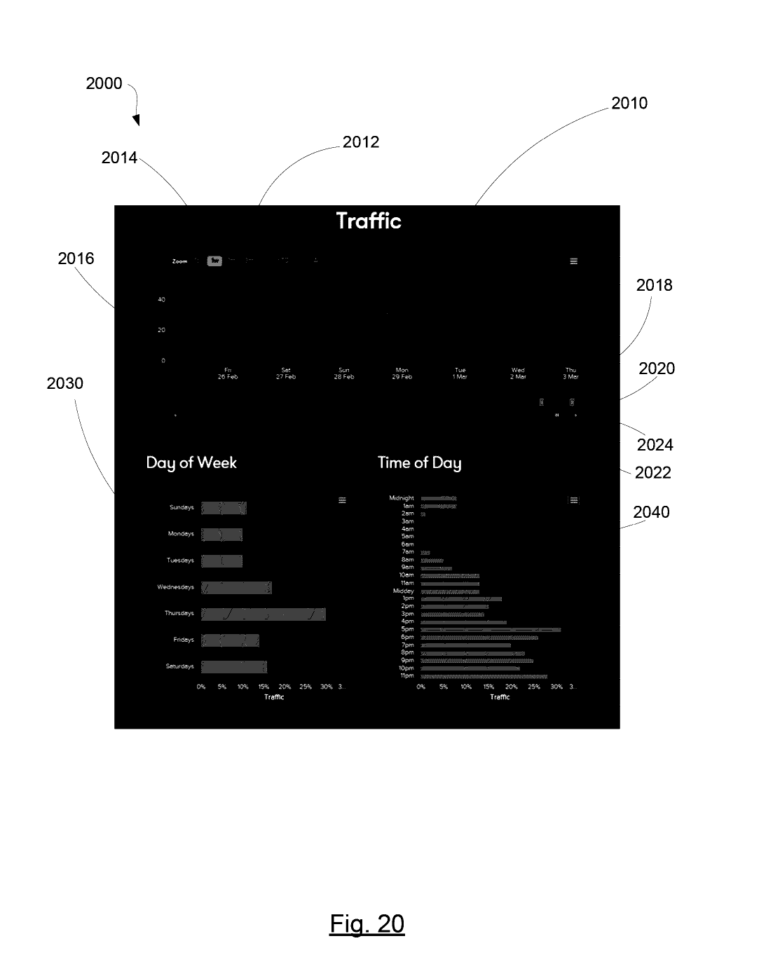

The displays 600 and 700 are some examples of ways in which the feedback and activity data can be presented to a user on a client device 140. Other displays and types of information can be generated and provided to a user via a client device 140. In particular, the user interface module 420 of the server 130 may be configured to permit a user to configure the particular types of displays provided to, or viewable via, the client device 140. Additionally, certain parameters may be user configurable, such as the time over which certain data may be aggregated prior to being sent from the console 110 to the server 130, the number of seconds for which further feedback is locked out after a button press or times during which the console 110 or its sensors 112, 119 are to be powered down. According to some embodiments, example displays 600 and 700 may include user selectable options to allow for the display of confidence intervals for one or more of the displayed data sets. FIGS. 19 and 20, described in further detail below, provide further examples of screen displays showing feedback and activity data.

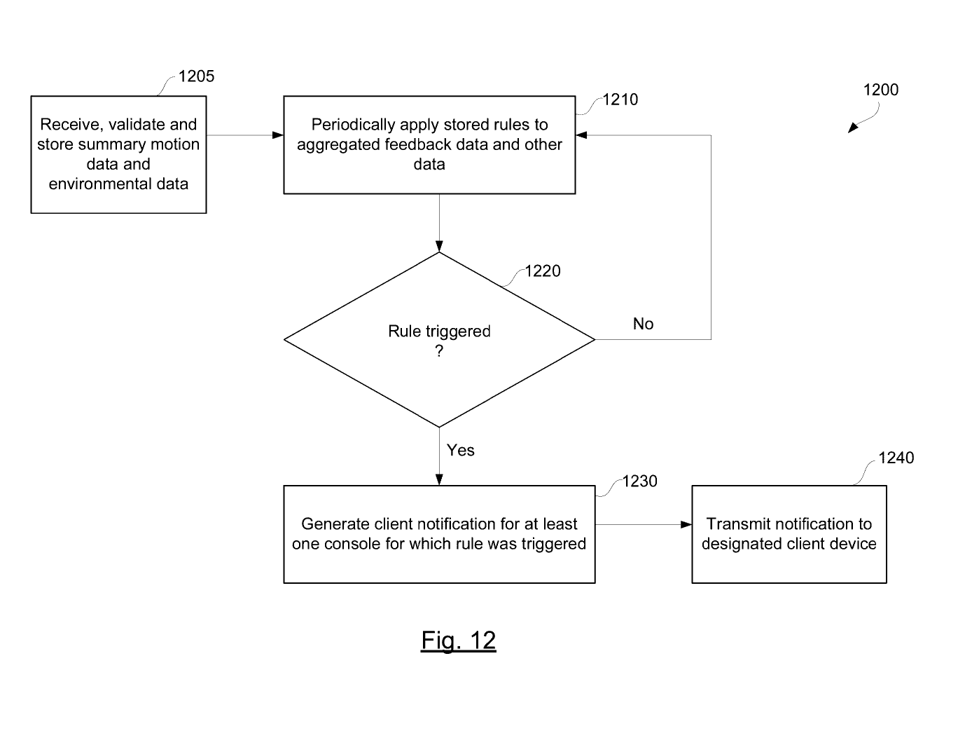

The server 130 has stored thereon or accessible thereto a series of rules for processing the data received via consoles 110. Referring also to FIG. 12, there is shown a flowchart of a method 1200 of automatically generating client notifications based on aggregated feedback data and other data. In method 1200, the stored rules are periodically applied to data received via the consoles 110 and stored in data store 135 in order to generate standard or preconfigured notifications that are generic or tailored to specific client circumstances. Over time, motion data, feedback data and environmental data may be received by the server 130, validated and stored within data store 135 (at 1205). At 1210, the server 130 executes the analytics module 422 to periodically apply the stored rules to the aggregated feedback data and other data. If at 1220 any of the conditions of the stored rules are met (i.e. triggered), then the analytics module 422 causes the notification module 424 to generate (at 1230) a client notification for at least one console 110 for which the rule was triggered. This notification is provided from the notification module 424 to the user interface module 420, which transmits the notification (at 1240) to an address (i.e. IP address, email address or other virtual but not physical address) to be accessed via a client device, such as client device 140. Thus, such notifications may be in the form of an electronic mail message, a text message, an in-app notification or other form of electronic messaging. The address used by user interface module 420 for sending the notification may be stored or configured when a user employs a client device 140 to register one or more consoles 110 with the server 130.

User interface module 420 may allow a user to configure, via a client device 140, various reporting criteria. For example, the user interface module 420 may allow a user to specify custom date ranges or intervals for reports, such as those shown in displays 600 and 700. In some embodiments, the stored rules may be configured by an administrative user or involve learning algorithms configured to mine insights from the data and generate and transmit such mined insights in email alerts or other electronic messages. For example, electronic notifications containing data-mined insights may be generated and transmitted to a user-specified IP address when certain criteria are met (e.g. “today looks like a bumper day: 25+% busier than Monday last week” or “you're having an unusually poor satisfaction day”). In another example, unsolicited electronic notifications may be automatically generated and transmitted to a user-specified IP address with mined insights generated by execution of stored rules (e.g. “Monday afternoons are your worst time” or “compared to other hair salons, you should be busier on Wednesdays”).

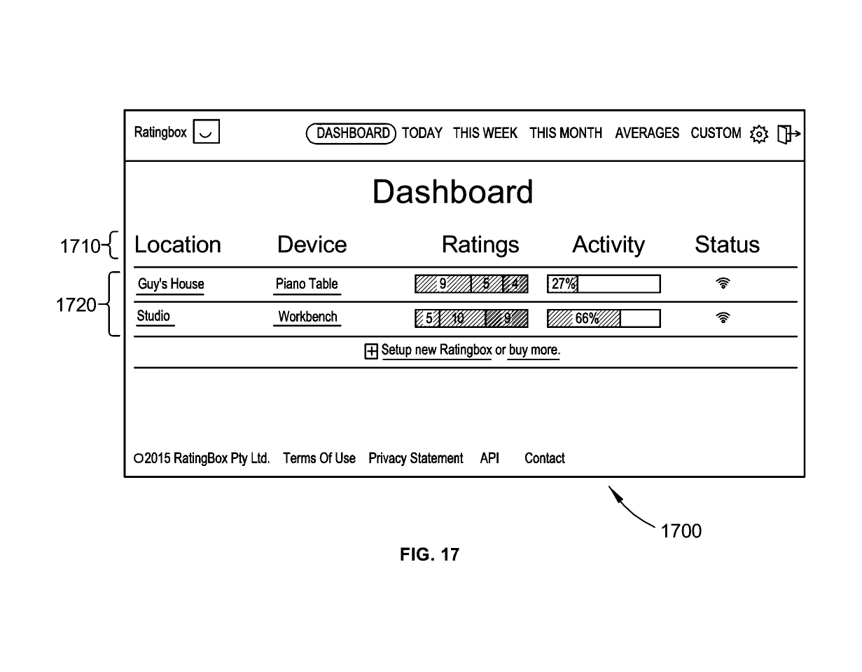

FIG. 17 is an example screenshot 1700 of a display on a client device 140. The screenshot 1700 illustrates a dashboard display to provide summary information to a user regarding each of a plurality of feedback consoles 110 that are registered to that user's account. The dashboard display includes a table comprising headings 1710, including for each registered feedback console 110 a location, a device name, recent ratings, recent activity and the communications connection status. For each feedback console 110 that is registered to the user, an entry appears in the table, comprising information under each of the headings 1710. For example, information 1720 corresponding to the headings 1710 is shown in screenshot 1700. Some of the information is user configured, such as the name of the device and the location, while other information includes summary data derived from regular data transmissions from the respective feedback consoles 110 (i.e. the ratings and activity data). The connection status information is determined according to the reliability of the connection between the server 130 and each feedback console 110, as determined from the perspective of the server 130.

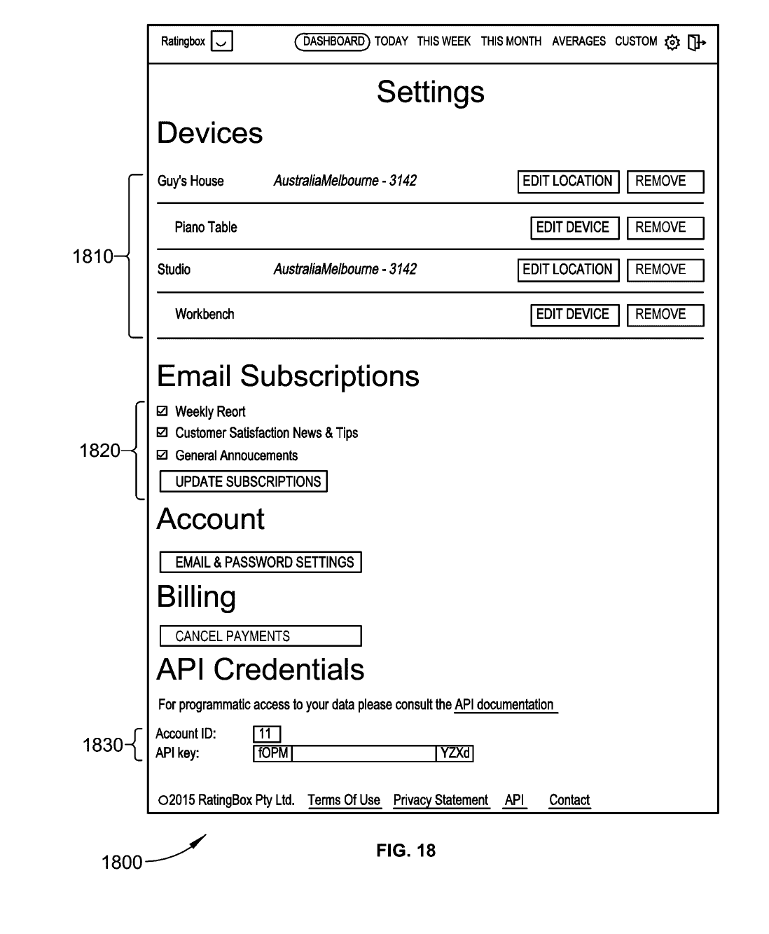

Each user account may have many feedback consoles 110 associated therewith and therefore the device list comprising the information 1720 can be long. The user configurable aspects of the dashboard summary can be edited, for example by clicking on suitable links or buttons, as shown in FIG. 18. Additionally, the dashboard display illustrated in screenshot 1700 may include a link to set up a new feedback console for that user account or to initiate a process to purchase further feedback consoles.

FIG. 18 is an example screenshot of a settings page displayed at a client device 140 according to code served from the server 130. The settings display 1800 comprises a device configuration section 1810, allowing a user to specify for each feedback console 110 a location name (shown in the example as “Guy's house”), a time zone, a country, an area or zip code, a commercial application category (e.g. “education and learning”) and a sub-category.

The settings page display 1800 also includes a subscriptions section 1820 that allows a user to configure its subscriptions to certain notifications. For example, the subscriptions section 1820 may include a checkbox for the user to indicate that it wishes to receive any one of: a weekly report, customer satisfaction news and tips, and general announcements. Other reports or notifications may be included within the subscription options and the section may also include an “update subscriptions” button in order to record changes to user selections.

The settings display 1800 may further allow account and billing settings to be viewed and/or modified. Further, the settings display 1800 may provide information 1830 concerning API credentials. The information 1830 may include an account ID and an API key, which may be a randomly generated unique identifier linked in data store 135 to the account identifier. The API credential information 1830 can be used to allow certain customers/users to develop code to directly and automatically interface with server 130 and data store 135 to extract desired information and optionally change device configuration data.

The API allows remote (server or client) device access to the motion data and to feedback data stored in data store 135 based on the pressing of the feedback buttons. The API may further allow remote device access to other stored sensor data associated with one or more of the consoles, where that data has been received from sensors other than the motion sensor, for example such as temperature sensors, humidity sensors and other environmental sensors. The API may further allow remote device access to aggregated data and/or computed metrics stored in data store 135 associated with one or more of the consoles. Where the aggregated data and/or computed metrics are associated with feedback consoles 110 for which an API request does not indicate appropriate authorisation, the information provided in response will not contain any private information, instead showing average numbers or total numbers over classes or large sets of feedback consoles 110.

The API can be used to access near real-time data received from all feedback consoles 110. This API takes a simple, REST (representational state transfer)/JSON (Java Script Object Notation)-style approach. Data accessed via the API is generally reported within a certain time, such as 1, 2, 3, 4 or 5 minutes, of an event occurring.

The API may be provided with rate limits for data requests or alternatively without hard rate limiting.

Authentication
http://api.ratingbox.com/ENDPOINT/?id=YOUR_ACCOUNT_ID&key=YOUR_API_KEY

All requests to the API must be accompanied by an account ID and API key. These credentials can be obtained by accessing the settings pane for a user's account, for example.

A listing of feedback consoles 110, 1310, 1510 for a particular account can be obtained by transmitting a device list request to the API, such as:

curl
“http://api.ratingbox.com/device/list/?id=YOUR_ACCOUNT_ID&key=YOUR_{—}
API_KEY”

The above command returns JSON structured like this:

{
“status”: “success”,

“count”: 2,
“data”: {

“devices”: [

{

“id”: 1,
“name”: “Front Counter”,
“location”: “Southside Restaurant”,
“timezone”: “Australia/Melbourne”

},
{

“id”: 2,
“name”: “Restroom”,
“location”: “Southside Restaurant”,
“timezone”: “Australia/Melbourne”

}

]

}

}

HTTP Request

GET
http://api.ratingbox.com/device/list/?id=YOUR_ACCOUNT_ID&key=YOUR_A
PI_KEY

Query Parameters

| Parameter | Required | Description |
|---|---|---|
| id | yes | account ID |
| key | yes | secret API key |

Returns

| Attribute | Description | Format |
|---|---|---|
| status | Whether the query succeeded or | success or fail |
| | not | |
| count | Number of devices in the result | int |
| devices.id | Unique identifier of this device | int |
| devices.name | Name given to this device | string |
| devices.location | Name of the location where this | string |
| | device resides | |
| devices.timezone | Timezone of the location where | IANA zone info |
| | this device resides | key (aka the |
| | | Olson time zone) |

Get Activity Levels

Curl
http://api.ratingbox.com/device/activity/?id=YOUR_ACCOUNT_ID&key=YO
UR_API_KEY&device=1&days=1”

The above command returns JSON structured like this:

```
{
  “status”: “success”,
  “count”: 6,
```

“data”: {

“activity”: [

{

“timestamp”: “2015-08-17T00:21:02.586Z”,
“level”: 81

},
{

“timestamp”: “2015-08-17T01:21:02.729Z”,
“level”: 76

},
{

“timestamp”: “2015-08-17T02:21:02.605Z”,
“level”: 0

},
{

“timestamp”: “2015-08-17T03:21:02.523Z”,
“level”: 0

},
{

“timestamp”: “2015-08-17T04:21:02.369Z”,
“level”: 100

},
{

“timestamp”: “2015-08-17T05:21:02.525Z”,
“level”: 29

}

]

}

}

This endpoint retrieves physical activity/motion records for a specific feedback console 110.

The activity may be defined as the (relative) amount of human movement within approximately 30′ (10 m) of the motion detector 112 of a feedback console 110.

The activity level is stored as a percentage of the time motion is detected around the device for the previous 1 hour. For example, a value of 50 means that during the previous 1 hour, (presumably human) motion was detected around the feedback console 110 half of the time.

HTTP Request

GET
http://api.ratingbox.com/device/activity/?id=YOUR_ACCOUNT_ID&key=YO
UR_API_KEY&device=1&days=1

Query Parameters

| Parameter | Required | Description |
|---|---|---|
| id | yes | Your account ID |
| key | yes | Your secret API key |
| device | Yes | The device ID (see List Devices) |
| days | no | Number of days to retrieve records for. |
| | | Valid range: 1 to 90. Defaults to 1 |

Returns

| Attribute | Description | Format |
|---|---|---|
| status | Whether the query succeeded or not | success |
| | | or fail |
| count | Number of records in the result set | int |
| ratings.timestamp | UTC time for the end of the recorded hour | int |
| ratings.rating | Negative: −1, Neutral: 0, Positive: 1 | int |

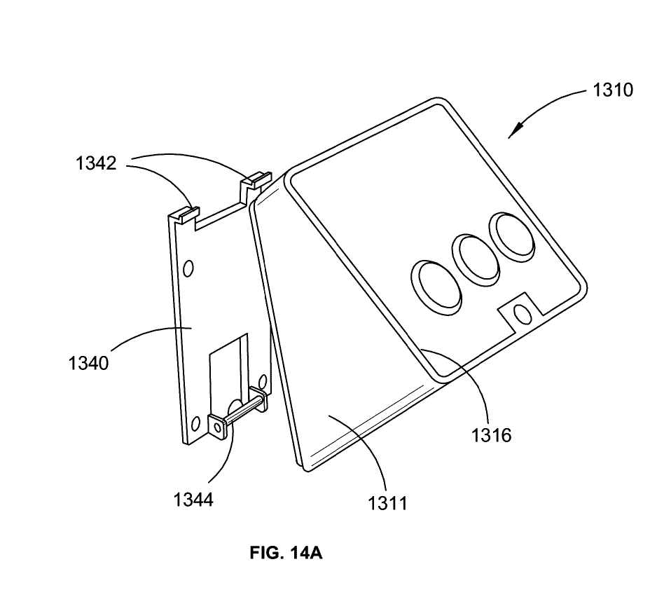

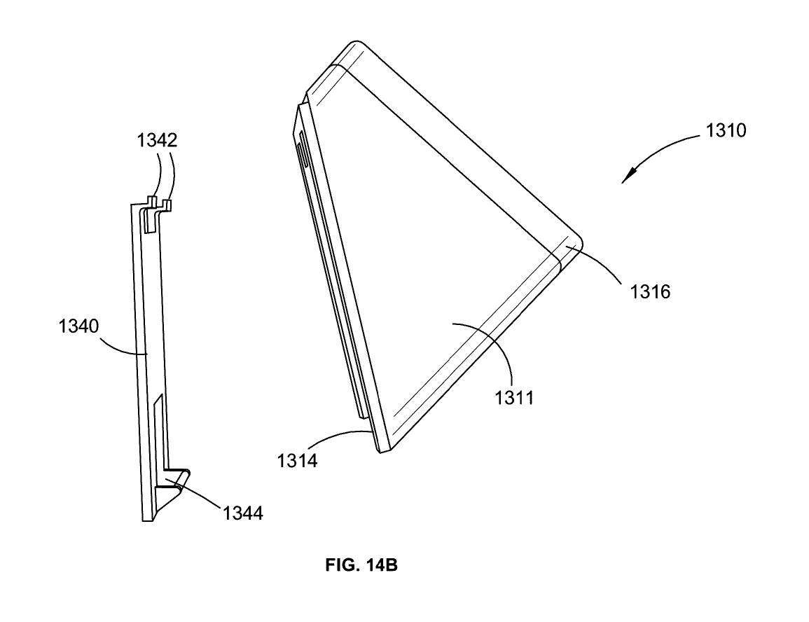

Referring now to FIGS. 13, 14A and 14B, a feedback console 1310 according to further embodiments is described in further detail. The feedback console 1310 is identical in function and operation to feedback console 110 but the housing of feedback console 1310 is somewhat different, having no shroud or side shields around the device interface area 1312 and allowing for mounting of the housing 1311 on a wall via a wall mount 1340. Feedback console 1310 has the same feedback buttons 221, 222 and 223 as feedback console 110 and also has the same motion sensor 112, although it is disposed towards a bottom section of the device interface 1312. The device interface 1312 may have a display such as that shown in FIG. 5, for example.

The housing 1311 of the interface 1310 may be configured to present the device interface 1312 at an angle to the user, on the assumption that the user will be standing in front of the feedback console 1310, looking down at it at about an average waist height. Feedback console 1310 may have at least one foot or foot portion 1314 to provide increased frictional engagement with a counter surface upon which the feedback console 1310 may rest.

The feedback console 1310 may have an interface section 1316 that includes the device interface 1312, the buttons 220, 221, 222, 223 and the motion detector 112. This section 1316 may be configured to be reversible so that its orientation can be turned 180 degrees to allow it to be wall mounted in a manner shown in FIGS. 14A and 14B, for example. Suitable catches or latches or other attachment structure on the housing 1311 may be employed to allow section 1316 to be thus reorientated.

As shown in FIGS. 14A and 14B, feedback console 1310 may be wall mounted, for example using a wall mount 1340 that has upper and lower mounting protrusions 1342, 1344. The lower mounting protrusions 1344 may include suitable apertures, recesses or other structure to accommodate the presence of a mains power supply cable connecting into the back of the feedback console 1310. The back of the housing 1311, as seen in FIG. 14B, may have mating recesses (unobscured by the foot portion 1314) to mate with and couple to the mounting protrusions 1342, 1344.

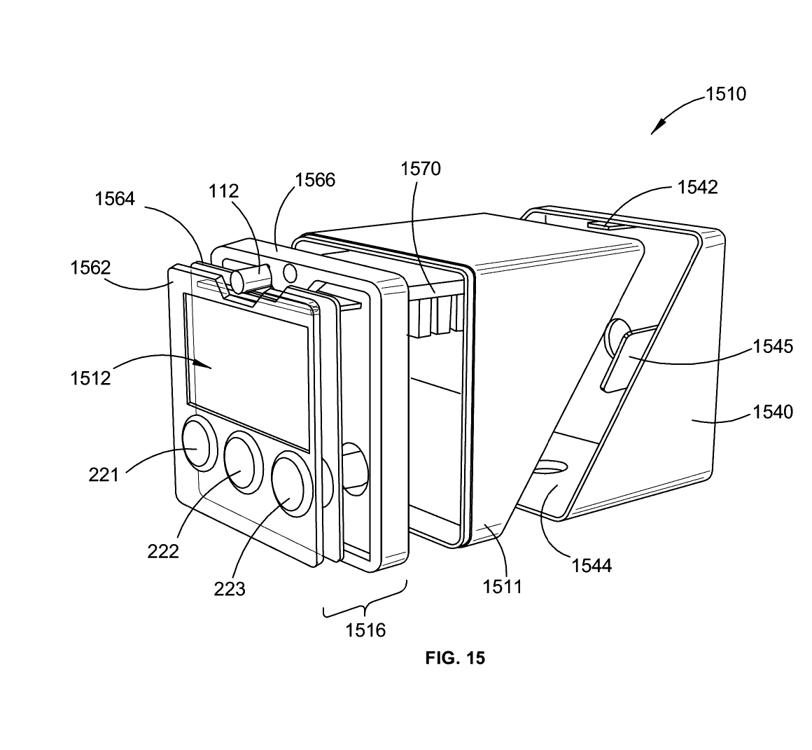

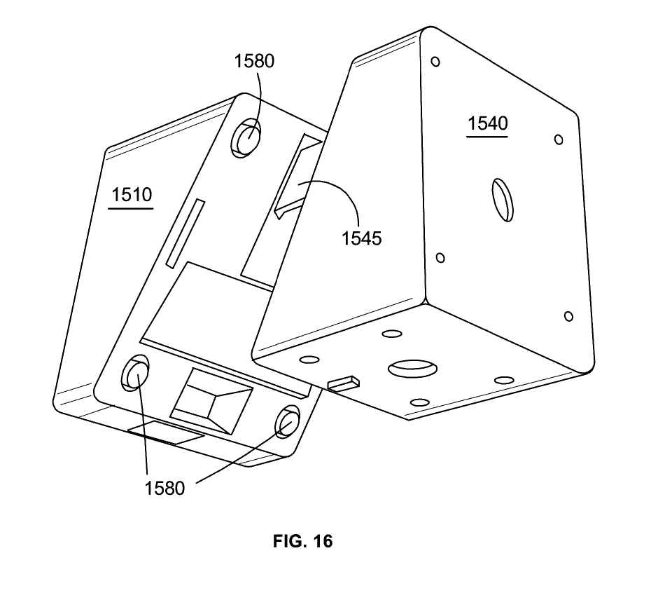

Referring now to FIGS. 15 and 16, a further feedback console embodiment 1510 is shown and described, being configured to interact with a different wall mount 1540. As with feedback console 130, feedback console 1510 is identical in function and operation to feedback console 110, but includes some different physical configuration features. Feedback console 1510 comprises a housing 1511 to which a front section 1516 is, in normal use, connected. The front section 1516 comprises an outer transparent plate 1562, an optional textured or coloured backing plate 1564 and a main backing plate 1566. The feedback buttons 221, 222 and 223 are received through apertures in the plates 1562, 1564 and 1566. The motion detector 112 is received in an aperture in the main backing plate 1566. However, the transparent outer plate 1562 is manually removable in order to allow placement of a different message or question to users of the feedback console 1510, following which the outer plate 1562 is replaced, with the message then forming part of the device interface 1512. The console housing body 1511 comprises mounting structure on an opposite side from the feedback interface to mount the console to a mounting bracket.

FIG. 15 illustrates an example printed circuit board 1570 (PCB) to which the electrical outputs of the feedback buttons 221, 222, 223 and motion sensor 112 are coupled. The PCB 1570 may carry the components described above in relation to FIG. 3 to perform the feedback monitoring and data transmission functions described herein.

Feedback console 1510 can be mounted to a wall mount 1540 via the housing mounting structure. The wall mount 1540 has upper latching protrusions 1542 and a lower support section 1544, plus mounting guides 1545 to mate with the housing mounting structure. The lower support 1544 may have at least one aperture formed therein to allow passage of a mains power supply cable for connection to a suitable power supply port on the housing 1511. The wall mount 1540 may have wall-mounting apertures on each of two differently oriented mounting faces in order to allow the feedback console 1510 to be mounted in different orientations, for example.

Feedback console 1510 need not be wall mounted. Rather, the housing 1511 may carry feet 1580 having increased friction engaging portions to rest on a counter, for example. If the feedback console 1510 is attached to wall mount 1540, then the feet 1580 may be hidden by outer walls of the wall mount 1540.

Referring to FIGS. 19 and 20, example user displays 1900 and 2000 are described. User displays 1900 and 2000 may be used in addition or as an alternative to user displays 600 and 700 in some embodiments. Like displays 600 and 700, user displays 1900 and 2000 may be displayed to a user of a client device 140 via a browser application or a purpose-built application (“app”) 450, for example. Displays 1900 and 2000 effectively provide summary information of analytics of the feedback and motion data received at server 130 over time by one or more consoles 110. For example, an owner or manager of the establishment 118 within which the console 110 is located may wish to access the accumulated feedback and activity (motion) data for a day, a week, or other period of time via client device 140. The user interface 420 of server 130 may therefore generate and serve data and/or code to client device 140 (upon appropriate authentication and data requests received from client device 140) in relation to one or more feedback consoles 110 that are associated with a client account. For example, a café owner may wish to consider analytics displays, such as 1900 and 2000 for a single console 110 in a single establishment 118, while a franchisor may wish to consider analytics for multiple feedback consoles 110 positioned in multiple different franchise establishments 118.

The example display 1900 shown in FIG. 19 may include various graphics, including charts, graphs, plots or other illustrative depictions of the data received via one or more consoles 110. The display 1900 may be directed towards providing a summary of feedback for a selected time period, and may comprise a graph 1910, a time period selection bar 1920, a bar chart 1930 and a bar chart 1940. Graph 1910 may be a bar chart in some embodiments, showing ratings or feedback for a particular period. According to some embodiments, each bar of graph 1910 may show positive ratings 1951, neutral ratings 1952 and negative ratings 1953 as separate sections of the bar, which may be of different colours or tones, or may be otherwise visually distinguishable. Graph 1910 may have an axis 1916 showing the number of ratings for each bar, and a time axis 1918 showing the time or date across which the displayed ratings were received. According to some embodiments, graph 1910 may be superimposed with active text upon mouse over, displaying additional information about the portion of the graph at which the mouse pointer is located, such as the date or time period, the number of positive ratings, the number of neutral ratings and the number of negative ratings.

A user may be able to select which period to view using selectable options 1914. According to some embodiments, selectable options may allow a user to choose between one day, one week, one month, three months, six months, the year to date, one year, or all. Selecting “one month”, for example, may cause graph 1910 to show feedback received in the last month, while selecting “all” may cause graph 1910 to show all recorded ratings. FIG. 19 shows the “one month” option as the selected option 1914. Once selected, selected option 1914 may become visually distinguishable from the unselected options, such as by adopting a different colour or brightness, for example.

According to some embodiments, a user may alternatively or additionally be able to select a time period for viewing using time period selection bar 1920. Time period selection bar 1920 may have a slidable minimum 1922 and a slidable maximum 1924, to allow a user to adjust the date limits between which ratings are shown. According to some embodiments, choosing a selectable option 1912 may cause selection bar 1920 to automatically adopt the maximum and minimum range defined by the selectable option. According to some embodiments, adjusting the range shown by selection bar 1920 may cause selected option 1914 of selectable options 1912 to become deselected. According to some embodiments, time period selection bar 1920 may display a proportionally scaled version of graph 1910 along its length, to allow a user to see data outside the selected time period window at a glance.

Bar chart 1930 may show a customer satisfaction score or net promoter rating calculated based on the ratings received, as distributed over the days of the week. For example, one bar of the graph may show the average customer satisfaction rating for Mondays in the selected time period, one may show the average customer satisfaction rating for Tuesdays in the selected time period, and so on. Bar graph 1930 may include lines indicating the levels at which the customer satisfaction score is deemed poor, satisfactory, or excellent, in some embodiments. The bars of bar graph 1930 may adjust automatically as the time period defined by selectable options 1912 and/or selection bar 1920 changes.

Bar chart 1940 may show a customer satisfaction score or net promoter rating calculated based on the ratings received, as distributed over time periods in a day. For example, one bar of the graph may show the average customer satisfaction rating for between midnight and 1 am in the selected time period, one may show the average customer satisfaction rating for between 1 am and 2 am in the selected time period, and so on. Bar graph 1940 may include lines indicating the levels at which the customer satisfaction score is deemed poor, satisfactory, or excellent, in some embodiments. The bars of bar graph 1940 may adjust automatically as the time period defined by selectable options 1912 and/or selection bar 1920 changes.

The example display 2000 shown in FIG. 20 may include various graphics, including charts, graphs, plots or other illustrative depictions of the data received via one or more consoles 110. The display 2000 may be directed towards providing a summary of activity detected for a selected time period, and may comprise a graph 2010, a time period selection bar 2020, a bar chart 2030 and a bar chart 2040. Graph 2010 may show detected movement, activity or traffic measured for a particular time period. Graph 2010 may have an axis 2016 showing an amount of activity detected, and a time axis 2018 showing the time or date across which the displayed activity was detected. According to some embodiments, graph 2010 may be superimposed with active text upon mouse over, displaying additional information about the portion of the graph at which the mouse pointer is located, such as the date or time period, and the traffic percentage.

A user may be able to select which period to view using selectable options 2014. According to some embodiments, selectable options may allow a user to choose between one day, one week, one month, three months, six months, the year to date, one year, or all. Selecting “one month”, for example, may cause graph 2010 to show activity measured in the last month, while selecting “all” may cause graph 2010 to show all recorded activity data. FIG. 20 shows the “one week” option as the selected option 1914. Once selected, selected option 2014 may become visually distinguishable from the unselected options, such as by adopting a different colour or brightness, for example.

According to some embodiments, a user may alternatively or additionally be able to select a time period for viewing using time period selection bar 2020. Time period selection bar 2020 may have a slidable minimum 2022 and a slidable maximum 2024, to allow a user to adjust the date limits between which measured activity is shown. According to some embodiments, choosing a selectable option 2012 may cause selection bar 2020 to automatically adopt the maximum and minimum range defined by the selectable option. According to some embodiments, adjusting the range shown by selection bar 2020 may cause selected option 2014 of selectable options 2012 to become deselected. According to some embodiments, time period selection bar 2020 may display a proportionally scaled version of graph 2010 along its length, to allow a user to see data outside the selected time period window at a glance.

Bar chart 2030 may show the level of measured activity or traffic as distributed over the days of the week. For example, one bar of the graph may show the level of measured activity or traffic for Mondays in the selected time period, one may show the level of measured activity or traffic for Tuesdays in the selected time period, and so on. The bars of bar graph 2030 may adjust automatically as the time period defined by selectable options 2012 and/or selection bar 2020 changes.

Bar chart 2040 may show the level of measured activity or traffic as distributed over time periods in a day. For example, one bar of the graph may show the level of measured activity or traffic for between midnight and 1 am in the selected time period, one may show the level of measured activity or traffic for between 1 am and 2 am in the selected time period, and so on. The bars of bar graph 2040 may adjust automatically as the time period defined by selectable options 2012 and/or selection bar 2020 changes.

According to some embodiments, example displays 1900 and 2000 may include user selectable options to allow for the display of confidence intervals for one or more of the displayed data sets. For example, confidence intervals may be optionally displayed on graph 1910, bar chart 1930, bar chart 1940, graph 2010, bar chart 2030, and/or bar chart 2040.

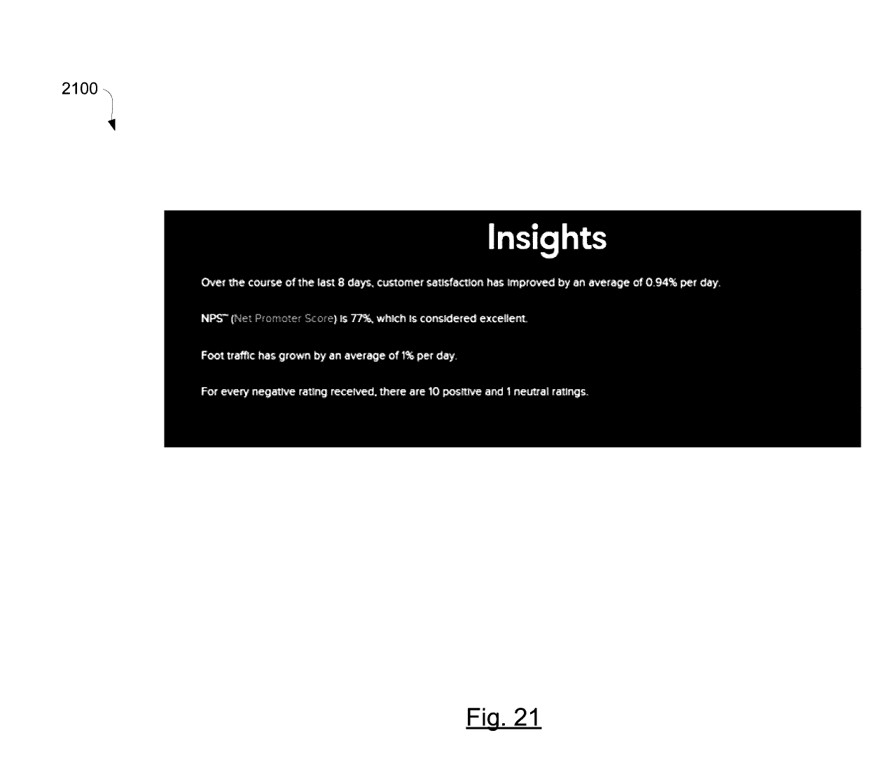

FIG. 21 shows an example user display 2100. User display 2100 may be displayed to a user of a client device 140 via a browser application or a purpose-built application (“app”) 450, for example. Display 2100 may provide summary information of analytics of the feedback and motion data received at server 130 over time by one or more consoles 110 further to the data provided by displays 6, 7, 19 and 20, in some embodiments. The user interface 420 of server 130 may generate and serve data and/or code to client device 140 (upon appropriate authentication and data requests received from client device 140) in relation to one or more feedback consoles 110 that are associated with a client account.

User display 2100 may provide statistics about the feedback ratings and motion data, such as whether ratings went up or down over a particular time period, what the average ratings were, how much traffic increased or decreased, and ratios between positive and negative feedback received. The data shown on user display 2100 may be generated based on mined insights generated by a learning algorithm, as described in further detail above. According to some embodiments, user display 2100 may provide the feedback ratings and motion data summaries in written form, offering an easy to understand and absorb snapshot of the data.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A feedback system, comprising:
a console comprising a feedback interface and a console body, the console body housing a processor and a wireless communications module, wherein the console body supports the feedback interface;
wherein the feedback interface comprises a plurality of feedback buttons, each feedback button comprising an image indicative of a different type of feedback, wherein pressing of one of the feedback buttons is recorded by the processor and communicated by the wireless communications module to a server;
wherein the console further comprises a motion detector positioned to detect motion occurring in a region towards which the feedback interface is facing, the motion detector being in communication with the processor to provide a detector output to the processor; and
wherein the processor is configured to communicate motion data based on the detector output to the server via the wireless communication module.

2. The system of claim 1, wherein the pressing of one of the buttons is communicated to the server within a short period of the pressing.

3. The system of claim 2, wherein the pressing is communicated to the server substantially immediately.

4. The system of claim 1, wherein the processor determines the motion data based on the detector outputs received over a first period of time.

5. The system of claim 4, wherein the first period of time is between about 1 minute to about 2 hours.

6. The system of claim 4, wherein the processor determines the motion data based on a sum of the detector outputs received over the first period of time.

7. The system of claim 1, wherein the motion detector comprises a passive infra-red sensor.

8. The system of claim 1, further comprising a temperature sensor arranged to sense a temperature in the vicinity of the console, the temperature sensor coupled to the processor to provide a temperature output to the processor, wherein the processor is configured to communicate temperature data based on the temperature output to the server.

9. The system of claim 1, further comprising a noise sensor arranged to sense an environmental noise level in the vicinity of the console, the noise sensor coupled to the processor to provide a noise level output to the processor, wherein the processor is configured to communicate noise level data based on the noise level output to the server.

10. The system of claim 1, further comprising at least one environmental sensor to sense environmental conditions in a vicinity of the console, the at least one environmental sensor coupled to the processor to provide environmental condition output to the processor, wherein the processor is configured to communicate environmental condition data based on the environmental condition output to the server.

11. The system of claim 1, wherein the console has associated therewith a private unique identifier, wherein communications to the server from the console comprise the private unique identifier.

12. The system of claim 11, wherein the console has associated therewith a public unique identifier, wherein communications to the server from the console comprise the public unique identifier and the private unique identifier.

13. The system of claim 1, wherein the processor is configured to cause one or more of the buttons to illuminate in response to an event, wherein the event is one of: one of the buttons being pressed; or motion being detected in front of the console by the motion detector.

14. The system of claim 1, wherein the console body comprises mounting structure on an opposite side from the feedback interface to mount the console to a mounting bracket.

15. The system of claim 1, further comprising the server.

16. The system of claim 15, wherein, for each communication received from the console, the server is configured to determine whether the private unique identifier is valid, wherein if the private unique identifier is determined to be valid, a data payload of the communication is stored in a data store accessible to the remote server, and wherein if the private unique identifier is determined not to be valid, the communication is discarded.

17. The system of claim 15, comprising multiple ones of the console each in communication with the server, wherein the server is configured to selectively allow a client device to access stored data received from one or more of the consoles.

18. The system of claim 15, wherein the server hosts an application programming interface (API) to allow remote device access to the motion data and to feedback data based on the pressing of the feedback buttons.

19. The system of claim 18, wherein the API is configured to require identification of an account identifier and an API key in a data request received by the API from a remote device in order to provide data in response to the request.

20. The system of claim 15, wherein the server is configured to cooperate with one or more client devices to provide a graphical user interface (GUI) on the one or more client devices, the GUI allowing display of information based on the motion data and based on the pressing of the feedback buttons.

21. A method for recording feedback, comprising:
receiving a feedback input at a feedback console comprising a feedback interface and a console body, the feedback input being received via one of a plurality of feedback buttons on the feedback interface;
receiving motion signals from a motion detector coupled to the console, the motion detector being arranged to detect motion occurring in a region towards which the feedback interface is facing; and
communicating feedback data based on the feedback input to a server remote from the console and communicating motion data based on the motion signals to the server.

22. The method of claim 21, wherein the communicating feedback data and the communicating motion data occur under different conditions.

23. The method of claim 21, wherein the motion data is based on aggregated motion information over a time interval.

24. The method of claim 21, wherein the feedback data is communicated to the server substantially immediately in response to receiving the feedback input.
